(19) United States
(12) Patent Application Publication
(10) Pub. No.: US 2026/0054997 A1
(43) Pub. Date: Feb. 26, 2026

(54) PRODUCTION OF HIGH PURITY SILICON AND SILICON CARBIDE FROM THERMO-CHEMICALLY TREATED ORGANIC BIO-SILICA AND CARBON BLACK GRANULES

(71) Applicant: PQ LLC, Malvern, PA (US)

(72) Inventors: Flavio Ernesto Ribeiro, Plainfield, IL (US); Steven Kolb, Tinley Park, IL (US)

(21) Appl. No.: 19/300,931

(22) Filed: Aug. 15, 2025

Related U.S. Application Data
(60) Provisional application No. 63/685,003, filed on Aug. 20, 2024.

(51) Int. Cl. C01B 32/97; C01B 33/025

(52) U.S. Cl. CPC C01B 32/97; C01B 33/025; C01P 2006/21; C01P 2006/80

(57) ABSTRACT

Embodiments relate to a method for producing a high purity silicon-containing product, such as metal silicon or silicon carbide. The method includes purifying a biogenic silica via a wet treatment process to provide a purified amorphous biogenic silica, calcining the purified amorphous biogenic silica to provide a carbon-silica feedstock, micronizing the carbon-silica feedstock to provide a micronized feedstock, agglomerating the micronized feedstock to provide carbon-silica agglomerates, and reacting the carbon-silica agglomerates to provide the high purity silicon-containing product.

### CROSS-REFERENCE TO RELATED APPLICATIONS

This patent application is related to and claims the benefit of priority of U.S. Provisional Application No. 63/685,003, filed on Aug. 20, 2024, the entire contents of which are incorporated by reference.

### FIELD OF THE INVENTION

Embodiments relate to a production process for manufacturing high purity silicon and silicon carbide from thermo-chemically treated organic bio-silica and carbon black. Cold and hot strength results of agglomerates made from high purity biogenic silica are in comparison with the standard raw materials that are used for silicon production and produced one of the purest forms of silicon carbide. The process is therefore achieved by thermo-chemically treating rice husks to remove impurities from bio-silica, followed by granulating the carbon containing bio-silica with carbon black using latex binder to provide high strength and uniformity to granules prior to Si and SiC production. The high purity organic bio-silica obtained from rice husks serves as an ideal source of carbon and silica for Si and SiC production.

### BACKGROUND OF THE INVENTION

Silicon and silicon carbide are traditionally produced in the chemical industry by the direct fusion of carbon with a silica source in an Acheson furnace between temperatures of 1600° C. to 2500° C. Various grades of silicon carbide are categorized based on their purity, grain size, and applications. Grades with low purity are considered technical grade, while grades with higher purity are described as pure or as ultra-high purity SiC for semiconductor manufacturing. The purity of Si and SiC are influenced by the purity of the raw material sources used in manufacturing. In traditional SiC production, raw materials such as petroleum coke, industrial charcoal, coal, and quartz sand are used for SiC production but contain impurities fused within the carbon and silica; requiring energy intensive processes due to crystalline morphology of particles. The crystalline morphology of these raw materials requires extended reaction times and higher furnace temperatures to achieve complete fusion of SiC.

Amorphous biogenic silica and carbon can be extracted from rice hulls. Lowering impurity levels of rice hulls are achieved by wet treatment applications using nitric acid, citric acid, and peroxide. Chemical treatment has the objective to remove oxide impurities from the rice hull raw material, from a total elemental concentration of 20,000 to 26,000 ppm, to a range of 200 to 1,000 ppm. Most of the impurities are flux elements such as calcium, magnesium, potassium, and sodium originating from residual fertilizers stored in the cellulose of the rice hull. Our patented purification process provides benefits to the silica properties for Si and SiC production.

After wet treatment purification of rice hulls, thermal treatment by calcination at high temperatures between 425° C. to 950° C. can be used to manipulate the carbon levels in the silica. Controlling carbon levels in the silica are dependent on furnace residence time, temperature, and rice hull feed rate which requires optimized process conditions for achieving a desired carbon concentration. After calcination, the resulting intermediate feedstock is an amorphous purified biogenic silica surrounded by uniform carbon in the range of 5% to 25%, preferably 20% to 22%, serving as an ideal source for SiC production.

The carbon containing intermediate feedstock may require micronisation to lower the particle size. The resulting particle size may range from 5 to 200 microns, preferably between 20 and 80 microns. Micronisation provides a benefit for narrowing the micron range in particle size distribution (PSD) in addition to transitioning elongated particles into spherical shapes. Micronisation may be required for the granulation process as narrow PSD, uniformity, and homogeneity are required to produce strong pellets.

Granulation can be achieved by intensive mixing applications with the use of a binder to maintain particle size, compressive strength, and moisture for a variety of applications. Spherical granules are often produced in applications in which the raw material needs to be transferred via conveyor belts to a furnace chamber, remaining intact with chemical stability for the designated reaction. Binders such as polyvinyl alcohol and sugars are used to ensure cohesion of chemical properties minimizing fines while maintaining high melting point temperatures for Acheson furnace reactions.

U.S. Pat. No. 8,470,279 describes a process for producing silicon containing products using rice hulls and straw by leaching sulfuric acid to remove non-silica minerals and metals while adjusting the mole ratio of fixed carbon to silica in the resultant product. The carbon and silica are intimately mixed on a micron scale and are characterized by high porosity, reactivity, and purity; containing volatile carbon to be used as an energy source for the production of silicon containing products.

U.S. Pat. No. 7,638,108 explains a process for developing high purity silicon containing products from rice hulls and straw by leaching silica containing plant matter with aqueous sulfuric acid under controlled temperatures, pressures, and reaction times to remove minerals while adjusting the mole ratio of fixed carbon to silica, followed by thermal treatment under controlled conditions to produce the desired product. The fixed silica to carbon is selectively adjusted to a ratio of 5:1 having an overall elemental purity of less than 1,000 ppm consisting of sodium, potassium, magnesium, calcium, manganese, iron, and phosphorus.

Philippines Patent No. 1-2011-502192 describes a process for manufacturing high purity silicon containing products such as silicon, silicon carbide, and silicon nitride by selectively determined carbon to silicon ratios. The products are derived from plant matter such as rice hulls and rice straw containing at least 3% weight silica. Methods are provided for making high purity silicon containing products by leaching silica containing plant matter by sulfuric acid under controlled temperatures. The mole ratio of silica to carbon in the intended products were achieved by adjusting between ranges of 1.37:1 and 5:1 without combustion; containing less than 1,000 ppm total mineral impurities. The carbon silica intermediate product was optionally devolatized with a gas selected from a group consisting of hydrogen, argon, nitrogen, and ammonia between a temperature range between 1350° C. and 2000° C.; wherein said high-purity, silicon-containing products are produced.

### BRIEF SUMMARY OF THE INVENTION

By implementing a wet treatment process to remove 99.93% impurities from the rice hulls followed by calcination to manipulate carbon levels in the silica, it has been discovered that high purity silicon and silicon carbide can be produced if the raw materials are homogenously granulated with latex binder prior to the Acheson furnace reaction. Rice hulls were subjected to a 4-step wet treatment process consisting of the following steps: 1) Chelation step with 10% nitric acid, 30% peroxide, and anhydrous citric acid for 1-hour at 70° C., 2) Hot water wash at 60° C. for 10 minutes, 3) 30% Peroxide for 1-hour at 43° C., and 4) Hot water wash at 43° C. for 10 minutes.

After wet treatment, the rice hulls were dried overnight followed by calcination at a temperature set point of 565° C. at a rice hull feed rate of 100 lbs/hour to generate a carbon-silica feedstock of 20:80%. The resulting intermediate feedstock was then micronized to a particle size of 20-microns (at D50) to narrow the PSD and eliminate elongated particles. The micronized carbon-silica was then homogenously mixed with high purity carbon black to increase the carbon concentration to 37.5% based on the stoichiometric reactions:

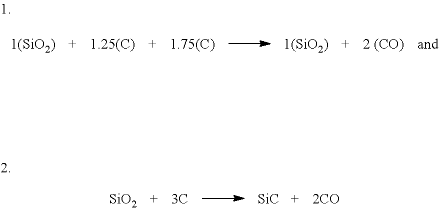

Once the carbon black has been thoroughly mixed into the carbon-rice hull silica, the intermediate mixture was then intensively mixed on the Eirich RV02E to begin granulation. Water was added to the carbon-silica mixture to initiate granulation development followed by the application of a latex binder diluted 1:1 with water to produce granules at a particle size of 2-4 mm with a moisture concentration of 30.78%. The resulting granules were dried overnight to allow the latex to cure the surface and pores of the carbon-bio-silica granules. After drying, compressive strength tests determined granules were suitable for the Acheson furnace for Si and SiC production (see Table 3).

The Acheson furnace was used to investigate the feasibility of SiC production and for its use at the industrial scale for commercial volumes. The temperature was set to a target of 1850° C. Once the target temperature was achieved, it was maintained for 1-hour before cooling to 25° C. Temperature close to the bottom of the graphite chamber was monitored throughout the process. Before and after the experiment, the masses of the sample and graphite crucible were measured to estimate mass loss resulting from the reaction between silica and carbon. Samples collected from the crucible were subjected to further chemical analysis using X-ray fluorescence (XRF) and LECO techniques to determine the amount of SiC produced (see Table 1).

The mass loss observed in the pellets during the experiment primarily resulted from the decomposition of the binder and, secondarily, from the reaction between carbon and silica within the pellet. Sixty-minute holding period at 1850° C. was provided in the reaction chamber, marked as “SiC Reaction Residence Time” in the temperature plot (see FIG. 1). The XRD pattern indicates that most of the peaks correspond to silicon carbide, specifically matching closely with the SiC-3C polymorph β-SiC (see FIG. 2).

In an exemplary method of producing a high purity silicon carbide, the method comprises the steps of providing a rice hull; purifying the rice hull via wet treatment; calcining the rice hull to obtain a carbon-silica feedstock; micronizing the carbon-silica feedstock; granulating the carbon-silica feedstock with a high purity carbon source, such as carbon black, and a binder, such as a latex binder, to obtain carbon-silica granules; and reacting the carbon-silica granules via Acheson furnace to obtain a high purity SiC.

In some embodiments, the purity of the rice hull silica is 99.93%

In some embodiments, the carbon-silica feedstock has an elemental concentration of less than 700 ppm.

In some embodiments, the carbon-silica feedstock has a carbon concentration of 5-25%, preferably 20-22%.

In some embodiments, the step of calcination comprises conducting calcination with a suspension furnace.

In some embodiments, the high purity carbon black has a purity of 99.98%.

In some embodiments, latex is diluted 1:1 with water.

In some embodiments, the carbon-silica feedstock is micronized to a particle size of 5-200 microns, preferably 20-80 microns.

In some embodiments, the carbon-silica granules are a particle size between 0.5-6 mm, preferably between 2-4 mm.

In some embodiments, the carbon-silica granules have a moisture concentration of 25-35%, preferably between 30-31%, such as 30.78%.

In some embodiments, the silicon carbide produced is a SiC-3C polymorph β-SiC.

In some embodiments, the silicon carbide formed is a particle size of 5-20 microns.

In some embodiments, the step of producing SiC comprises an Acheson furnace, heating the carbon-silica granules to a temperature of 1700-2100° C., preferably 1800-1900° C., most preferably 1850° C. for 1-hour.

In an exemplary method of producing high purity silicon, the method comprises the steps of providing a rice hull; purifying the rice hull via wet treatment; calcining the rice hull to obtain a carbon-silica feedstock; micronizing the carbon-silica feedstock; pelletizing the micronized carbon-silica feedstock with high purity carbon source, such as carbon black, and a binder, such as Sevol™ 523, to obtain carbon-silica agglomerates; and reacting the carbon-silica agglomerates via Archeson furnace to obtain high purity silicon.

In some embodiments, the carbon-silica agglomerates contain 7.5% Sevol™ 523.

In some embodiments, the carbon-silica agglomerates are a particle size between of 0.5-6 mm.

In some embodiments, the purity of the rice hull silica is 99.93%.

In some embodiments, the carbon-silica feedstock has an elemental concentration of less than 700 ppm.

In some embodiments, the carbon-silica feedstock has a carbon concentration of 5-25%, preferably between 20-22%.

In some embodiments, the step of calcination comprises conducting calcination with a suspension furnace.

In some embodiments, the high purity carbon black has a purity of 99.98%.

In some embodiments, the carbon-silica feedstock is micronized to a particle size of 5-200 micron, preferably 20-80 microns.

In some embodiments, the step of producing Si comprises an Acheson furnace, heating the carbon-silica agglomerates to a temperature of 1700-2100° C., such as 1760° C., for 1-hour.

Further features, aspects, objects, advantages, and possible applications of the present invention will become apparent from a study of the exemplary embodiments and examples described below, in combination with the figures, and the appended claims.

### BRIEF DESCRIPTION OF THE FIGURES

The above and other objects, aspects, features, advantages, and possible applications of the present invention will be more apparent from the following more particular description thereof, presented in conjunction with the following drawings. It should be understood that like reference numbers used in the drawings may identify like components.

FIG. 1 is a temperature profile and gas analysis during experiment with composite pellets for SiC formation.

FIG. 2 is a fitted diffractogram of pellets after experiment at 1850° C. in argon atmosphere.

FIG. 3 shows elemental distribution of silicon, carbon, and oxygen in the selected area of SiC particles formed at bottom portion of pellet.

FIG. 4 displays the bottom, middle, and top layers of the crucible.

FIG. 5 illustrates the results of the softening at 1713° C. and melting at 1760° C. on alumina substrate.

### DETAILED DESCRIPTION OF THE INVENTION

The following description is of an embodiment presently contemplated for carrying out the present invention. This description is not to be taken in a limiting sense but is made merely for the purpose of describing the general principles and features of the present invention. The scope of the present invention should be determined with reference to the claims.

Embodiments relate to a production process for manufacturing high purity silicon and silicon carbide. Granules made from thermo-chemically treated organic biogenic silica and a carbon source, such as carbon black, agglomerated with a binder, such as a latex binder, produces high purity silicon and silicon carbide in high yields. After chemical reaction at 1850° C. for 1-hour, 99.32% of the high purity biogenic silica reacted with carbon to produce 76.7% SiC and 54.02% Si. It has been found that pelletizing high purity biogenic silica with carbon black and latex produces high production yields for Si and SiC production compared to industrial processes.

In purification of biogenic silica, chemical wet treatment process may be essential to remove most impurities from the rice husks. An exemplary wet treatment process is described in U.S. Pat. No. 11,618,684, the entire contents of which are incorporated by reference. Lowering impurity levels of rice hulls are achieved by wet treatment applications using nitric acid, citric acid, and peroxide. Chemical treatment has the objective to remove oxide impurities from the rice hull raw material, from a total elemental concentration of 20,000 to 26,000 ppm, to a range of 200 to 1,000 ppm. In this application, we achieved a total elemental concentration of 740 ppm of the biogenic silica.

After the wet treatment purification process, thermal treatment by calcination at 565° C. via cyclonic suspension furnace was used to manipulate the carbon level in the biogenic silica to 20%. The rice hull feed rate was controlled at a rate of 140 lbs/hour for a combustion residence time of 15 seconds to burn excess plant matter and organic material. After calcination, the resulting intermediate feedstock is an amorphous purified biogenic silica surrounded by 5-25%, preferably 20-22%, uniform carbon subjected to micronisation to lower the particle size, such that the resulting particle size may range from 5 to 200 microns. preferably from 20 to 80 microns.

In preferred embodiments, the application of the latex binder to high purity biogenic silica and carbon black provides uniformity, high-strength, and increased performance for the production yields of silicon and silicon carbide. The latex binder provides chemical stability for the SiC chemical reaction, thus improving production times, lower temperatures, and shortened residence times.

In an exemplary embodiment, a method for producing high purity SiC comprises providing a rice hull; purifying the rice hull via wet treatment; calcining the rice hull to obtain a carbon-bio-silica feedstock; micronizing the carbon-bio-silica feedstock to a particle size of 5 to 200 microns, preferably 20 to 80 microns; granulating the carbon-bio-silica feedstock with carbon black (e.g., 1 part of carbon black to 3.57 parts of carbon-bio-silica feedstock) with water (e.g., 1 part of water to 3.21 parts of existing mixture of carbon black and carbon-bio-silica) and addition of latex binder (e.g., diluted 1:1 w/water; 1 part of latex binder to 8.56 parts of existing mixture containing carbon-bio-silica, carbon black, and water) to a granule size of 0.5 to 6 mm, preferably 2 to 4 mm; and reacting the intermediate mixture via Acheson furnace to obtain a high purity SiC.

The carbon-bio-silica of the described embodiments may be a pure carbon-bio-silica and may have an elemental concentration less than 1,000 ppm, preferably less than 800 ppm, most preferably less than 750 ppm. The carbon-bio-silica may have a carbon concentration between 5 and 25%, preferably between 20 and 22%, most preferably 20%. The carbon-bio-silica may further have a free humidity of less than 3%, preferably less than 1%, most preferably less than 0.5%. Additionally, the carbon-bio-silica may have a particle size of less than 22-microns, preferably less than 21-microns, most preferably at 20-microns. It is contemplated that the carbon-bio-silica may be derived from any suitable source, including but not limited to rice hulls.

The carbon black of the described embodiments may be pure carbon black and may have an elemental concentration less than 200 ppm, preferably less than 150 ppm, most preferably less than 100 ppm. The carbon black may further have a free humidity of less than 0.5%, preferably less than 0.25%, most preferably 0.08%. It is contemplated that the carbon black may be derived from any suitable source.

The latex of the described embodiments may have a water concentration of less than 76%, preferably less than 75%, most preferably less than 74.80%. The latex may further have a solids concentration of more than 24%, preferably 25%, most preferably 25.20%. It is contemplated that the latex may be derived from any suitable source.

The granulation process of the described embodiments may be conducted on an intensive mixing unit such as a granulator. It is contemplated that a granulation process may be performed under ambient temperatures, such as between 20-22° C., preferably between 21° C.-22° C., most preferably at 22° C. It is further contemplated that the granulation process may be performed under controlled mixing for 15 minutes, with vessel operating between 60-80 rpms in clockwise direction, preferably 65-75 rpms, most preferably between 70-75 rpms. The rotor of the granulator should be operated at counterclockwise mixing speeds of 10-20 m/sec, preferably 10-15 m/sec, most preferably 15 m/sec.

The granulation mixture of carbon-bio-silica and carbon black should be adjusted to a moisture concentration of 20%-22%, preferably 21%-22%, most preferably 21.29%; followed by application of the latex binder to adjust the moisture to a final concentration of 25%-35%, preferably 30%-31%, more preferably 30.5%-31%, most preferably 30.78%. The latex binder concentration should be 10%-11%, preferably 10.5%-11%, most preferably 10.46%. The granules should be adjusted to a particle size of 0.5-6 mm, preferably 2-4 mm, more preferably 2.5-3.5 mm, most preferably 3 mm. The intermediate carbon-bio-silica granules may be collected after mixing and subjected to a drying oven at 50° C. to allow latex binder to cure for 24-hours.

The cured intermediate carbon-bio-silica granules are then reacted in an Acheson furnace with an operating temperature between 1700° C.-2100° C., preferably 1,800° C.-1900° C., more preferably 1,850° C.-1900° C., most preferably 1,850° C. for a residence time of 1-hour. The reacted high purity SiC is then obtained for chemical analysis.

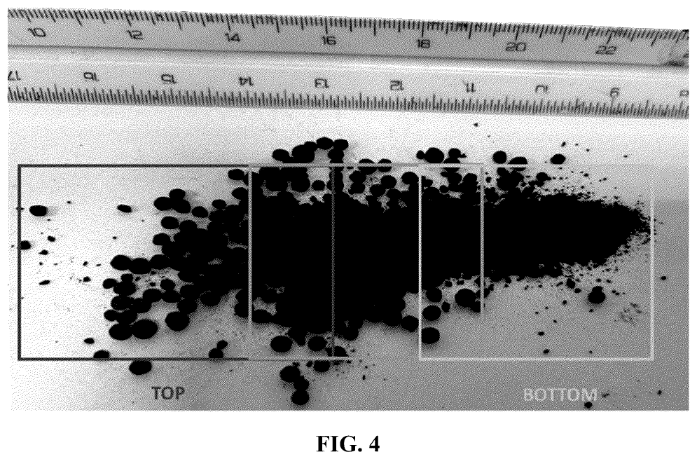

Before and after the experiment, the masses of the sample and graphite crucible were measured to estimate mass loss resulting from the reaction between silica and carbon. Samples collected from the crucible were subjected to further chemical analysis using X-ray fluorescence (XRF) and LECO techniques to determine the amount of SiC produced. To assess and quantify silicon carbide formation, the reacted samples from the experiments were divided for analysis using X-ray diffraction (XRD), chemical analysis, and microscopic examination. Samples obtained post-experimentation were segregated into three sections based on their height within the crucible: “Top”, “Middle,” and “Bottom,” (See FIG. 4).

The samples underwent chemical analysis at an ISO accredited laboratory in Norway. This analysis was aimed to determine the quantities of SiC, Si, total carbon, and free carbon present in the reacted pellets. The free carbon analysis was conducted using a multiphase carbon analyzer, specifically the LECO RC-612, which operates as a ramped instrument, heating samples from 100 to 1000° C. in an oxygen atmosphere. Additionally, the LECO CS-444, a combustion instrument, was employed to analyze total carbon in an oxygen atmosphere. Both instruments function by burning the sample in oxygen and detecting the resulting CO₂ using an infrared (IR) cell. Furthermore, the total Si content was determined using an XRF instrument. To calculate the total SiC, Si within SiC, and elemental Si in each sample, the following formulas were employed: C-total, C-free, and Si-total represent total carbon, free carbon, and total Si, respectively:

$$\% SiC = ( \% {C}_{t o t a l} - \% {C}_{f r e e} ) \times Molar mass of SiC / Molar mass of carbon \qquad ( 1 )$$

$$Si in SiC = \% SiC \times Molar mass of Si / Molar mass of SiC \qquad ( 2 )$$

Electron probe microanalysis (EPMA) characterization was conducted using a double Cs-corrected cold FEG JEOL ARM200F, operating at 200 kV. Samples, as per the bifurcation depicted in FIG. 4, were mounted and coated before analysis. Image analysis of the samples were carried out using ImageJ software to determine the area fraction of silicon carbide formed in the reacted composite pellets.

The high purity silicon and silicon carbide may have an overall elemental concentration of 600-750 ppm, which is considered an ultra-pure grade. Accordingly, it is contemplated that providing a product with this elemental purity would be advantageous for various markets. Those skilled in the art would find many potential uses for the product such as a feedstock for power inverters.

Power inverter manufacturers typically produce high purity silicon and silicon carbide for a wide range of markets: electric vehicles, solar power, abrasives, grinding tools, ceramics, or body armor; typically, all use the same grade of Si and SiC for all applications. As the requirements in the silicon and silicon carbide market become more stringent, it is clear that a higher quality, more consistent, and environmentally efficient product is required where the other markets can use current commercial grade silicon and silicon carbide.

The silicon carbide market for power inverters would benefit from a high purity SiC, a higher production yield would lower the cost of high purity SiC for customers while delivering a small standard deviation of the significant metals and effective performance for power inverter specifications.

Solar silicon manufactures require a purity of 99%, with thermo-chemically treating rice hull silica to a high purity through a consistent and cost-effective engineering processes; delivering a high purity silicon would be advantageous for this industry as the current demand for these products is high.

### Examples

To confirm the finding that high purity silicon and silicon carbide were produced, a series of experiments were conducted.

### Experiment 1

The primary feasibility of SiC production using pellets produced using high purity carbon-bio-silica from rice hulls along with carbon black in a lab-scale Acheson furnace. The experimental setup for testing silica agglomerates for SiC production is based on the method presented by Ringdalen [1]. In the simulated SiC production experiments, a laboratory-scale vertical Acheson furnace was utilized to assess the feasibility of producing silicon carbide using pellets derived from silica obtained from rice hulls and carbon black. The furnace employed was a vertical graphite tube furnace (Thermal Technology Model 1000-3560-FP20). During the experiment, a graphite crucible was filled with 15 grams of pellets and argon was utilized as the carrier gas at a flow rate of 0.1 L/min. The furnace is equipped with a type C thermocouple capable of measuring temperatures up to 1500° C. and a pyrometer for temperatures above 1500° C. Additionally, a gas analyzer (ABB 2020) and micro-gas chromatography (Agilent 990 Micro-GC) were connected to the off-gas lance to detect the concentrations of specific gases formed during the experiments.

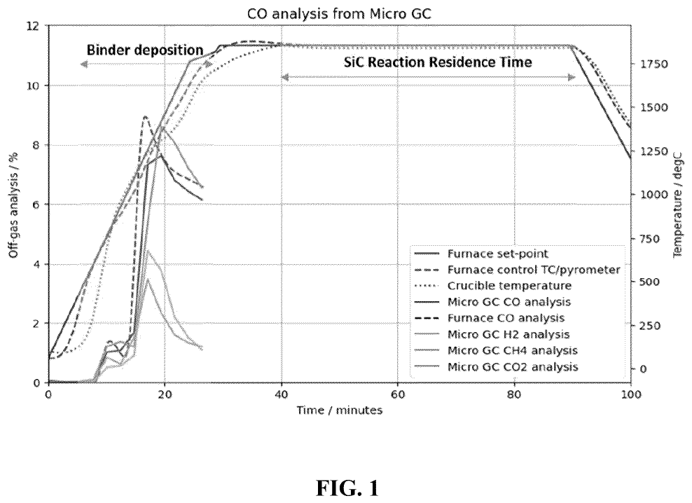

FIG. 1 shows the temperature profile and gas analysis during the experiment with composite granules for SiC formation.

The mass loss observed in the pellets during the experiment primarily resulted from the decomposition of the binder and, secondarily, from the reaction between carbon and silica within the pellet. FIG. 1 illustrates the temperature program along with the gas analysis measured during the experiment. The initial mass loss, marked as “Binder decomposition,” likely resulted from the breakdown of the organic binder used in pellet preparation. The latex binder decomposed at temperatures between 500-750° C. During decomposition, signals of CO, CH₄, and H₂ were recorded by the micro-GC. In the next phase, a sixty-minute holding period at 1850° C. was provided in the reaction chamber, marked as “SiC Reaction Residence Time” in the temperature plot. During this phase, reactions as indicated by equations (1)-(4) occurred, leading to the formation of silicon carbide in the pellets:

Overall reaction for silicon carbide (4) can be denoted by (1) as:

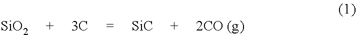

In addition to formation of SiC according to reaction, SiO gas may be formed, as represented by reaction (2), which further reacts with carbon to SiC according to reaction (3).

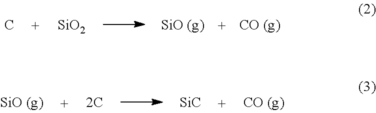

Furthermore, some of the forming SiC may react with SiO₂ to form SiO gas according to reaction (4).

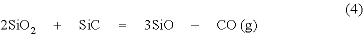

### Experiment 2

Mineralogical analysis was performed using XRD analysis. Powder XRD data were collected in Bragg-Brentano mode with a Bruker D8 DaVinci diffractometer equipped with a Cu-Kα source. Samples were prepared in back-loaded sample holders to minimize preferred orientation effects, and data were collected across an angular range of 5-80 degrees 2θ. Rietveld analysis was conducted using Bruker Topas analysis software, with structure models for the crystalline phases obtained from the Crystallographic Open Database. The fitted diffractogram was compared to Rietveld analysis to align the peak intensity data showing the spectrums closely align with SiC morphology.

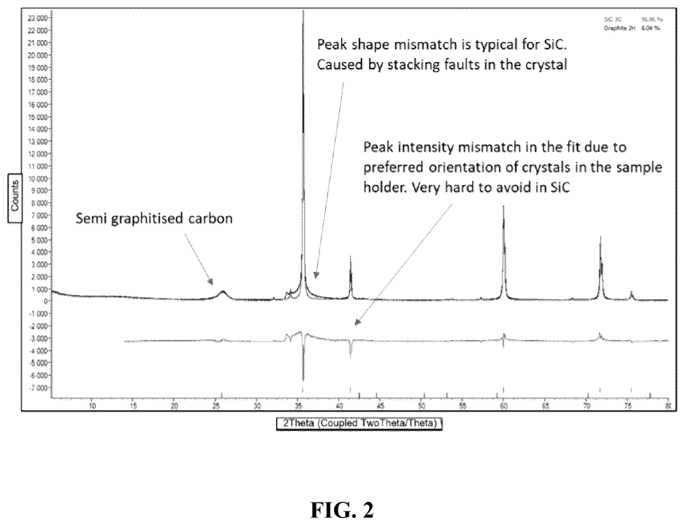

FIG. 2 displays the XRD analysis of the reacted pellets after experiment at 1850° C. in argon atmosphere fitted to Rietveld analysis.

The XRD pattern indicates that most of the peaks correspond to silicon carbide, specifically matching closely with the SiC-3C polymorph (β-SiC). Additionally, some traces of carbon were detected, likely due to the presence of unreacted carbon in the pellets.

### Experiment 3

Chemical analysis was conducted on the reacted pellets to quantify free carbon and total carbon by LECO analysis; and residual SiO₂ was quantified through previous analysis above. Silicon carbide formation was calculated using the stoichiometric reactions: 2(SiO₂)+1.25(C)+1.75(C)→1(SiC)+2 (CO) and SiO₂+3C→SiC+2CO. The results from the chemical analysis are presented in Table 1.

TABLE 1

| Parameter | Result (%) |
|---|---|
| Total Carbon | 44.95 |
| Free Carbon | 21.98 |
| SiC | 76.7 |
| SiO₂ | 0.68 |
| Si (Calculated) | 54.02 |

After one hour of reaction at 1850° C., only a nominal amount of silica remained, corroborating the results obtain ed from the XRD analysis. 99.32% of the high purity biogenic silica reacted with a high production yield of 76.7% SiC and 54.02% Si. In the traditional industrial processes for producing green SiC, production yields are typically around 25%. With this high efficiency reaction, the use of high purity carbon-bio-silica and latex as a binder to maintain chemical structure is advantageous for the Si and SiC industry.

### Experiment 4

EPMA-BSE analysis was conducted using a double Cs-corrected cold FEG JEOL ARM200F, operating at 200 kV. Samples, as per the bifurcation were mounted and coated before analysis. Image analysis of the samples was carried out using ImageJ software to determine the area fraction of silicon carbide formed in the reacted composite pellets to determine the phases, composition, and phase distribution. Elemental mapping techniques were employed to determine the phases among carbon, silicon, and oxygen.

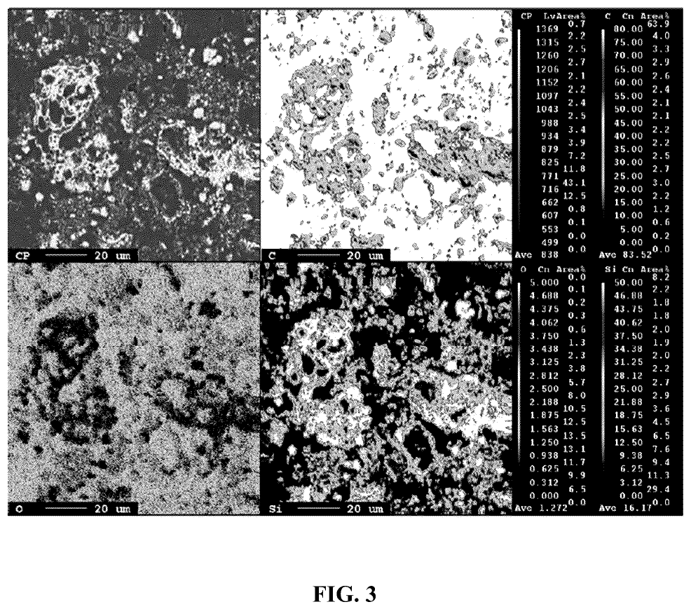

FIG. 3 presents microscopy images of the samples taken from different positions of the pellet layer, indicating that the reaction intensity observed higher in the samples extracted from the bottom portion of the crucible. Elemental distribution of Si, carbon and oxygen in the selected area of SiC particles formed at bottom portion of pellet.

FIG. 4 displays the bottom, middle, and top layers of the crucible.

As depicted in FIG. 3, the observed mushroom-type morphology is primarily composed of SiC particles, uniformly distributed throughout the pellets. This analysis confirms that SiC formation occurs uniformly across the pellets, with particle sizes of less than 5 microns. The topochemical behavior, following a gas solid reaction pathway, is evident at the edges of the silicon carbide particles. A sharp boundary between the SiC and unreacted carbon can be clearly observed.

### Experiment 5

The softening and melting properties of the high purity SiO2 derived from rice husks are crucial considerations for silicon production. If silica softens and melts at lower temperature regions, particularly near the top of the charge in silicon furnaces, the high viscosity of quartz can lead to the formation of a sticky mass, impeding the natural movement of raw materials deeper into the furnace. Hence, it is essential to assess the softening and melting behavior. To prevent oxidation during the test, the chamber was flushed with argon and evacuated. Thermal imaging camera equipped with the necessary equipment recorded images of phase transformation as a function of time and temperature at intervals of every 5 seconds. This test provides insights into the softening, melting, and flow temperatures of the test sample, benchmarked against standard quartz material typically used in silicon production. Three different experiments were conducted to investigate the impact of substrate and gas environment on the softening and melting properties. The experimental conditions for these tests are outlined in Table 2.

TABLE 2

| | | Gas Flow | Temperature | Holding |
|---|---|---|---|---|
| Test No. | Substrate | (L/min) | (° C.) | Time (min) |
| 1 | Carbon | Ar = 0.1 | 1760 | 60 |
| 2 | Alumina | Ar = 0.1 | 1760 | 60 |
| 3 | Carbon | CO = 0.1 | 1760 | 60 |

The softening and melting behaviors were investigated under various gas atmospheres and on different substrates to assess their impact on the melting process.

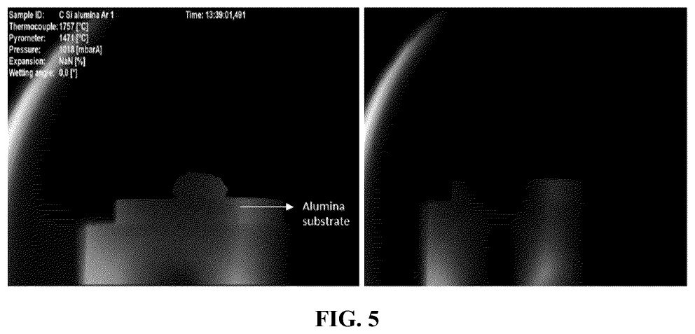

FIG. 5 illustrates the results of the softening at 1713° C. and melting at 1760° C. on alumina substrate.

During Test No. 1 and 3, a whisker-like structure was observed on the surface. This formation is likely attributed to the reaction between silica, carbon black, and the carbon substrate, resulting in the formation of silicon carbide and carbon monoxide. Throughout the experiment, no complete melting was observed, and the contact angle remained unchanged. In Test No. 2, the phase transformation behavior of the agglomerate differed from that observed in Test No. 1 and 3. Minimal whisker formation was observed, with varying phase transformation temperatures. At the conclusion of the experiment, the contact angle between the substrate and the sample reached zero, indicating complete wetting. This behavior can be attributed to the reaction between silica and the alumina substrate, leading to the formation of a more stable phase known as mullite.

In the study of Ringdalen [1], the phase transformation behavior of traditional quartz for Si production was monitored for melting, determining a minimum temperature of 1825° C. was needed for complete melting. The results of our study demonstrate that high purity carbon-bio-silica had a lower the melting point of 1760° C. for Si production due to lower amount of impurities than traditional quartz. Additionally, the lower melting point temperature can be elucidated by considering the crystallinity of the silica present in the samples. Quartz possesses a well-defined tetrahedral monomer unit, resulting in a polymeric interconnected network [1]. In contrast, the biogenic silica derived from rice hulls exhibits an amorphous structure, as confirmed by the XRD analysis depicted in FIG. 2. With having a lower melting point raw material for Si production, this requires less energy for industrial applications such as lowering operating temperatures, less fuel, and shortened residence times. These characteristics would benefit a silicon producer by lowering the operating manufacture costs.

### Experiment 6

Drop tests were conducted to evaluate the strength of the carbon-bio-silica agglomerates for Si production. Samples were released from a height of 2 meters onto a steel plate. The drop number was determined by counting the number of drops until the sample fractured. Ten samples were randomly selected for testing, with the drop number reported as the average value obtained from these ten trials.

The drop test indicates that these briquettes have a drop number exceeding 9, the results from the abrasion tests are presented in Table 3, indicating the ratio of particles sized above 6.3 mm and below 0.5 mm after tumbling.

TABLE 3

| Test No. | Agglomerate Type | Content | % >6.3 mm | % <0.5 mm |
|---|---|---|---|---|
| 1 | Briquettes | Rice hulls ash + carbon black | 93.4 | 6.4 |
| 2 | Briquettes | Rice hulls ash + carbon black | 93.6 | 5.6 |
| | | Requirements for industrial | — | >10% |
| | | charcoal | | |
| | | Requirements for | — | Max. 5% |
| | | Metallurgical coke | | |

Variations were observed between the parallels during the abrasion tests. The briquettes exhibit an abrasion index value of 6.1%±0.71. The abrasion test reveals that the briquettes generate fines of less than 0.5 mm, primarily due to the breakage of sharp edges around the briquettes. Overall, these briquettes demonstrate equal abrasion resistance to metallurgical coke but exhibit superior strength relative to industrial charcoal.

### Experiment 7

The breakage behavior was assessed through cold compression testing at room temperature. The tests were conducted using a 2.5 KN Zwick Roell, GmbH material testing machine. During testing, samples were positioned between the crossheads in a perpendicular orientation. The crosshead movement was maintained at a speed of 10 mm/min. Given the absence of an ISO testing standard specifically tailored for this type of agglomerates, ISO 4700:2007 guidelines were followed for comparison purposes. Eleven samples were subjected to testing, and the force-displacement curve for each sample was recorded. These briquettes exhibit notable resistance against compression loads, with the samples breaking in layers. The compression test is continued until the breakage force reaches 50% of the highest achieved breakage force, with detailed data provided in Table 4.

TABLE 4

| Cold Compressive Strength | | |
|---|---|---|
| (CCS) Selected results | Load (daN) | CCS (MPa) |
| Maximum | 115.15 | 11.20 |
| Minimum | 56.40 | 4.87 |
| Average | 86.32 | 8.40 |

In the Si production industry, typical compressive strength for industrial coal is much lower at 0.87-1.1 MPa. The results of our analysis indicate our samples have a 108% higher compressive strength than industrial coal, determining that our process produces a much stronger, and reliable feedstock for Si production.

The chemical and physical properties of the high purity silicon produced from thermo-chemically treated rice hull silica in this application would benefit the solar silicon industry. With traditional industrial processing having low production yields for high purity silicon, it is not a cost-effective process due to the long processing times and high cost of materials. With the technology presented having high purity greater than 99%, a lower melting point than quartz, a higher abrasion index than industrial charcoal, and latex binder to help maintain stoichiometric reaction via Acheson furnace process; these characteristics would be able to meet the high demand for high purity solar silicon products.

Although the description above contains specificities of the technology, they should not be interpreted as limitations to the scope of this invention, but as an example of a preferred embodiment. The scope of the present invention must be determined by the embodiments illustrated, but with the set of claims and its legal equivalents.

It should be understood that the disclosure of a range of values is a disclosure of every numerical value within that range, including end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatus and methods of using and making the same disclosed herein have been discussed and illustrated, it is to be distinctly understood that the invention is not limited thereto but may be otherwise variously embodied and practiced within the scope of the following claims.

### LITERATURE CITED

1) E. Ringdalen and M. Tangstad, “SOFTENING AND MELTING OF SiO 2, AN IMPORTANT PARAMETER FOR REACTIONS WITH QUARTZ IN Si PRODUCTION,” in Advances in Molten Slags, Fluxes, and Salts: Proceedings of The 10th International Conference on Molten Slags, Fluxes and Salts (MOLTEN16), 2016, pp. 43-51.

What is claimed is:

1. A method for producing high purity silicon-containing product, the method comprising:
purifying a biogenic silica via a wet treatment process to provide a purified amorphous biogenic silica;
calcining the purified amorphous biogenic silica to provide a carbon-silica feedstock;
micronizing the carbon-silica feedstock to provide a micronized feedstock;
agglomerating the micronized feedstock to provide carbon-silica agglomerates; and
reacting the carbon-silica agglomerates to provide the high purity silicon-containing product.

2. The method of claim 1, wherein the high purity silicon-containing product is silicon carbide.

3. The method of claim 1, wherein the high purity silicon-containing product is metal silicon.

4. The method of claim 1, wherein the wet treatment process comprises combining the biogenic silica and an acidic solution.

5. The method of claim 1, wherein the biogenic silica has an elemental impurity concentration less than 1000 ppm after purification.

6. The method of claim 1, wherein calcining the biogenic silica comprises heating the biogenic silica to a temperature between 425° C. and 950° C., and wherein the carbon-silica feedstock has a carbon to silica mass ratio between 5:95 and 25:75 after calcination.

7. The method of claim 1, wherein the carbon-silica feedstock has a D50 size distribution between 5 and 200 microns after micronisation.

8. The method of claim 1, agglomerating the carbon-silica feedstock comprises:
mixing the carbon-silica feedstock with a source of carbon to form an intermediate mixture;
mixing the intermediate mixture with a binder to provide the carbon-silica agglomerates.

9. The method of claim 1, wherein the carbon-silica agglomerates have a moisture content between 25 and 35% and a particle size between 0.5 mm and 6 mm.

10. The method of claim 8, wherein the binder is a latex binder.

11. The method of claim 8, wherein the source of carbon comprises carbon black.

12. The method of claim 1, further comprising:
drying the carbon-silica agglomerates prior to reacting the carbon-silica agglomerates to provide the high purity silicon-containing product.

13. The method of claim 1, wherein a production yield of silicon carbide after the step of reacting the carbon-silica agglomerates is between 25 and 80%.

14. The method of claim 1, wherein reacting the carbon-silica agglomerates comprising heating the carbon-silica agglomerates to a temperature between 1700° C. and 2100° C. for a residence time of one hour.

15. A high purity silicon carbide made by the method of claim 1.

16. The high purity silicon carbide of claim 15, wherein the silicon carbide is β-silicon carbide.

17. The high purity silicon carbide of claim 15, wherein the silicon carbide has an abrasion index value of 6.1%±0.71.

18. The high purity silicon carbide of claim 15, wherein the silicon carbide has a cold compressive strength between 4.87 and 11.20 MPa.

19. The high purity silicon carbide of claim 15, wherein the silicon carbide has an overall elemental concentration between 600 and 750 ppm.

20. A high purity silicon metal made by the method of claim 1.
